(19) United States
(12) Patent Application Publication
(10) Pub. No.: US 2011/0292759 A1
(43) Pub. Date: Dec. 1, 2011

(54) Structure for marine electromagnetic sensor streamer suited for manufacturing by extrusion

(76) Inventors: Gustav Göran Mattias Südow, Vallingby (SE); Ulf Peter Lindqvist, Segeltorp (SE); Andras Robert Juhasz, Hagersten (SE); Bengt Finnoen, Honefoss (SE)

(21) Appl. No.: 12/800,906

(22) Filed: May 25, 2010

(51) Int. Cl. G01V 1/38; B29C 45/14

(52) U.S. Cl. 367/20; 264/272.14

(57) ABSTRACT

A method for making a marine electromagnetic survey streamer includes affixing connectors to longitudinal ends of a strength member. At least one signal communication line is extended along the length of the strength member. The strength member, connectors, and at least one signal communication line form a mechanical harness. Electrodes are affixed to the mechanical harness at selected positions. The mechanical harness is drawn through a co-extruder. The co-extruder fills void spaces in the harness with a void fill material. The co-extruder applies a jacket to an exterior of the void filled harness.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates generally to the field of marine electromagnetic sensor streamers. More specifically, the invention relates to structures for such streamers and manufacturing methods affiliated with extrusion techniques.

Marine electromagnetic sensor streamers may be towed behind a survey vessel or other vessel in a body of water. An electromagnetic energy source is actuated at selected times, and measurements made by the various sensors on the streamer are detected and recorded for processing. An objective of such processing is to locate subsurface resistivity anomalies in the rock formations below the water bottom and to quantify content of materials such as petroleum that may be associated with such anomalies.

One typical marine electromagnetic sensor streamer includes a plurality of spaced apart pairs of electrodes, each pair coupled across the input terminals to a proximately positioned signal amplifier. The streamer may also include signal digitization and electrical to optical signal conversion devices so that voltage measurement signal transmission over the sometimes very long distance (up to several kilometers) will not itself induce substantial voltages in the signal lines connecting the measurement electrodes to the respective voltage measuring circuitry. One example of a marine seismic streamer structure is shown in U.S. Pat. No. 7,602,191 issued to Davidsson. A particular structure for electrodes is shown in U.S. Pat. No. 7,446,535 issued to Tenghamn et al.

It is known in the art to make marine seismic sensor streamers using a process called co-extrusion. U.S. Pat. No. 7,142,481 issued to Metzbower et al. describes a method and apparatus for using preassembled “cable harness”, including prewired sensors disposed in sensor holders, preassembled buoyancy spacers, and associated electronic cables and components. The preassembled harness is passed through a first extruder that fills void spaces in the harness with a liquid that is transformed afterward into a semi-stiff gel, e.g., by application of ultraviolet light. The gel filled harness is then passed through a second extruder which applies an external jacket made of, for example, polyurethane. Extrusion manufacturing has improved the efficiency of manufacturing seismic sensor streamers and has reduced their costs. Direct application of the device and method disclosed in the '481 patent to the manufacture of electromagnetic sensor streamers has not yet proven practical, primarily due to the number of places where devices must penetrate the jacket and enter the interior of the streamer, e.g., at the electrical connections to the electrodes, which are typically placed on the exterior of the jacket.

What is needed is a structure for a marine electromagnetic sensor streamer that can be manufactured using extrusion techniques.

### SUMMARY OF THE INVENTION

A method for making a marine electromagnetic survey streamer according to one aspect of the invention includes affixing connectors to longitudinal ends of a strength member. At least one signal communication line is extended along the length of the strength member. The strength member, connectors, and signal communication line form a mechanical harness. Electrodes are affixed to the mechanical harness at selected positions. The mechanical harness is drawn through a co-extruder. The co-extruder fills void spaces in the harness with a void fill material. The co-extruder applies a jacket to an exterior of the void filled harness.

A marine electromagnetic survey streamer segment according to one aspect of the invention comprises a strength member extending between longitudinal ends of the streamer segment. The segment further comprises connectors coupled to each end of the strength member. The segment further comprises at least one signal communication line extending along the strength member. The segment further comprises electrodes disposed at selected positions along the strength member. The segment further comprises a jacket coupled to the connectors and at least partially covering the strength member, the at least one signal communication line, and the electrodes. The segment further comprises void fill material filling void spaces within the jacket.

A marine electromagnetic survey streamer system according to another aspect of the invention includes a plurality of streamer segments each including a strength member extending between longitudinal ends of the segment, connectors coupled to each end of the strength member, at least one signal communication lines extending along the strength member between the connectors, and electrodes disposed at spaced apart locations along the strength member. A jacket at least partially covers the strength member, the at least one signal communication line, and the electrodes, and void fill material fills void spaces within the jacket. The system further includes a plurality of signal processing modules interconnected between adjacent streamer segments, each module including a pressure resistant housing and electronic circuits disposed therein for receiving measurements from part of the electrodes on each of the streamer segments coupled thereto, the circuits including devices for communicating voltage measurements made between respective pairs of electrodes along assembled streamer segments to a recording system on a survey vessel. Other aspects and advantages of the invention will be apparent from the following description and the appended claims.

### BRIEF DESCRIPTION OF THE DRAWINGS

FIG. 1 shows an example marine electromagnetic sensor streamer, according to an embodiment of the invention, being towed in a body of water.

FIG. 2 shows an example of a segment of the sensor streamer shown in FIG. 1.

FIG. 3 shows an expanded view of a location for placement of one of the electrodes shown on the segment in FIG. 2.

FIG. 4 shows an example structure for one of the electrodes.

FIGS. 5 and 6 show example buoyancy spacers that may be used with the streamer of FIG. 1.

FIG. 7 shows an example assembled mechanical harness, according to an embodiment of the invention, prior to extrusion processing.

FIG. 8 shows an example signal processing module that may be used between cable segments, according to an embodiment of the invention.

FIG. 9 shows an example cross head extruder that may be used to complete manufacture of the streamer segments, according to an embodiment of the invention.

### DETAILED DESCRIPTION

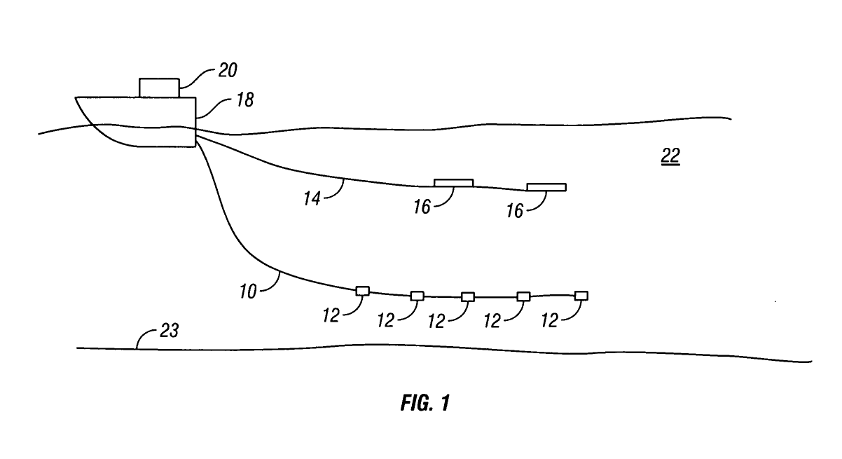

An example marine electromagnetic survey system, according to an embodiment of the invention, is shown generally in FIG. 1. The electromagnetic survey system includes a sensor cable 10 having thereon at longitudinally spaced apart positions a plurality of sensors 12. The sensors 12 and the configuration of the cable 10 will be explained in more detail below. The sensor cable 10 is shown being towed by a survey vessel 18 moving on the surface of a body of water 22 such as a lake or ocean. Towing the sensor cable 10 is only one possible implementation of a sensor cable. It is within the scope of the present invention for the sensor cable 10 to be deployed on the water bottom 23.

The vessel 18 may include thereon equipment, shown generally at 20 and referred to for convenience as a “recording system” that may include devices (none shown separately) for navigation, energizing electrodes or antennas for imparting an electromagnetic field in the formations below the water bottom 23, and for recording and processing signals generated by the various sensor modules 12 on the sensor cable 10.

The electromagnetic survey system shown in FIG. 1 includes a transmitter consisting essentially of electrodes 16 disposed at spaced apart positions along an electrically insulated source cable 14 that may be towed by the survey vessel 18 or by a different vessel (not shown). The source cable 14 alternatively may be deployed on the water bottom 23. The electrodes 16 may be energized at selected times by an electrical current source (not shown separately) in the recording system 20 or in other equipment (not shown) to induce an electromagnetic field in the formations below the water bottom 23. The current may be alternating current for frequency domain electromagnetic surveying or switched direct current (e.g., switching current on, switching current off, reversing current polarity, or sequential switching such as a pseudorandom binary sequence) for time domain electromagnetic surveying. The configuration shown in FIG. 1 may induce a horizontal dipole electric field in the subsurface when the electrodes 16 are energized by electric current. It is entirely within the scope of the present invention to induce vertical dipole electric fields in the subsurface, as well as to induce vertical and/or horizontal dipole magnetic fields in the subsurface. Inducing magnetic fields may be performed by passing electrical current through a loop antenna or solenoid coil. Accordingly, the direction of and the type of field induced is not intended to limit the scope of the invention. Further, the invention is applicable to use with both frequency domain (continuous wave) and transient induced electromagnetic fields.

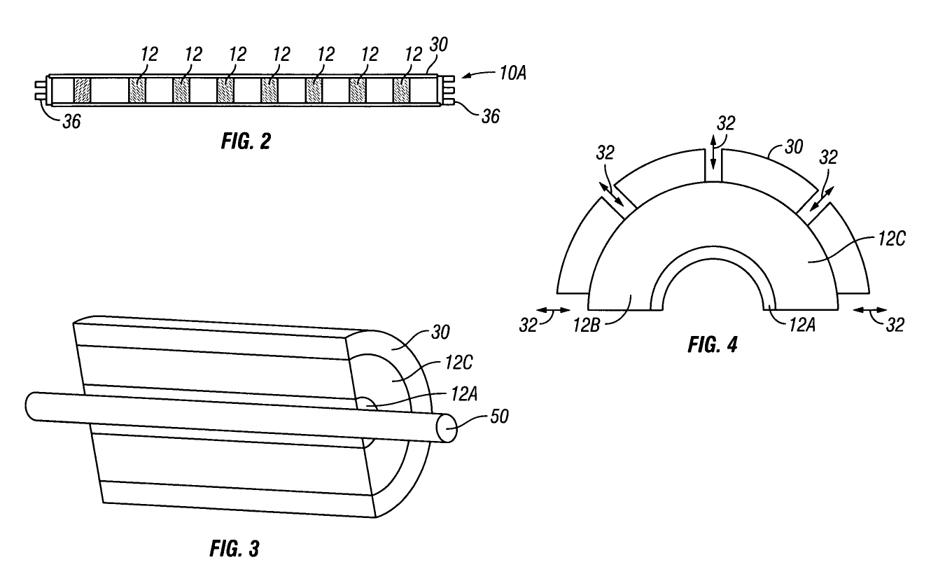

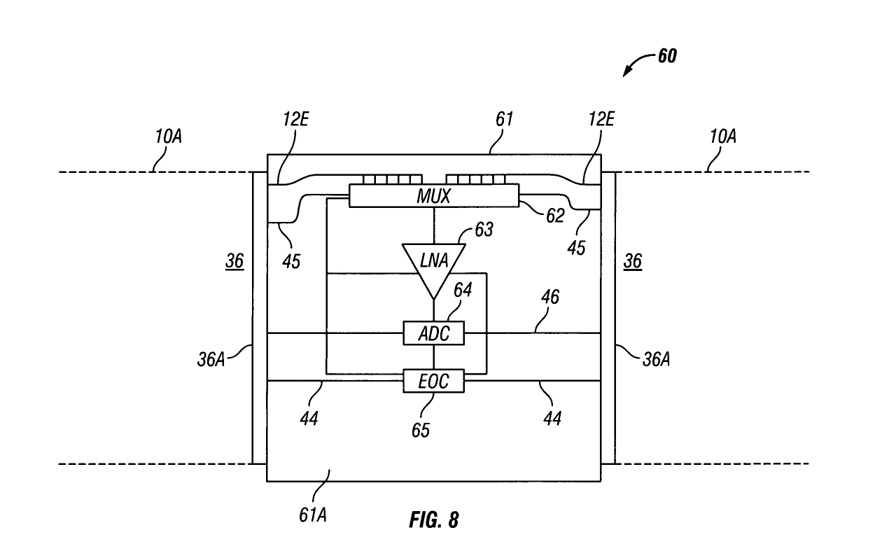

As will be appreciated by those skilled in the art, the sensor streamer 10 may extend behind the vessel 18 for several kilometers. Therefore, as a matter of convenience in the manufacturing and deployment of such streamers 10, and referring to FIG. 2, the streamer may be assembled from a plurality of longitudinal streamer segments 10A. Each segment 10A may be mechanically, electrically, and signal communicatively coupled to adjacent streamer segments using suitable connectors 36 affixed to the longitudinal ends of the segment 10A. As will be explained with reference to FIG. 8, some examples may include coupling the segments 10A at each longitudinal end to a signal processing module. The segment 10A is generally covered on its exterior surface by a jacket 30. In some embodiments, the jacket 30 may be made from flexible plastic, such as polyurethane. Examples of suitable locations for the electrodes 12 are shown in FIG. 2. There may be openings (e.g., 32 in FIG. 4) in the jacket at the longitudinal position of the electrodes such that the electrodes 12 may maintain electrical continuity with the body of water (22 in FIG. 1).

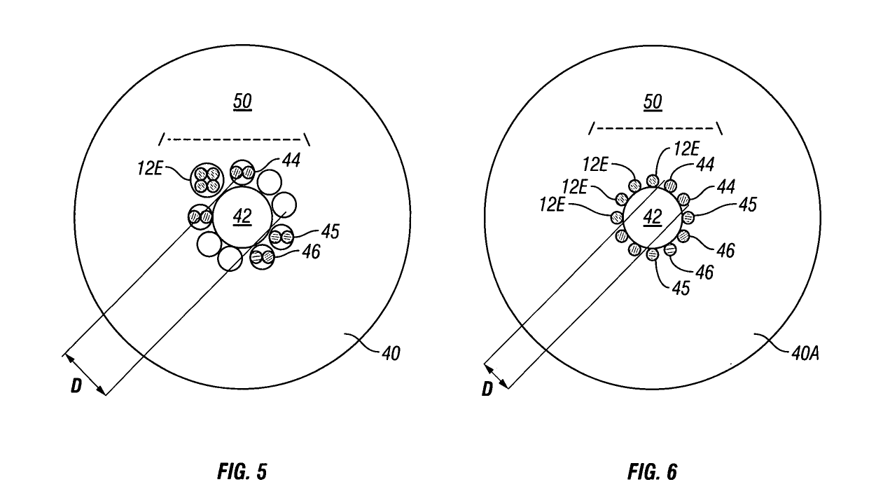

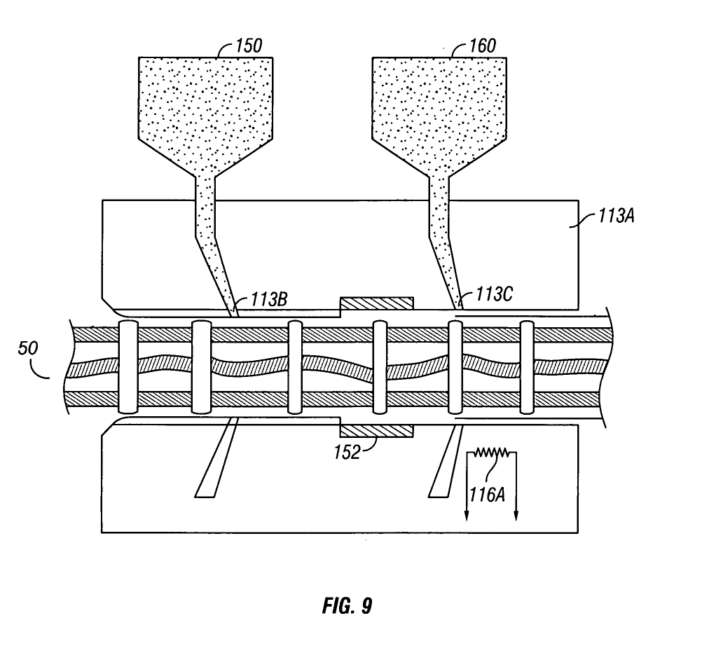

An example location for one of the electrodes (12 in FIG. 2) along the segment 10A is shown in expanded view in FIG. 3. During assembly of the segment 10A, a mechanical harness 50 is produced. The mechanical harness 50 will be explained in more detail with reference to FIGS. 5 and 6. Generally, the electrode (12 in FIG. 2) may be affixed to the exterior of the harness 50 and electrically connected to the harness 50. After extrusion processing (explained below with reference to FIG. 9), the electrodes (12 in FIG. 2) will be substantially fixed in position and enabled to be in electrical contact with the water in which the streamer is disposed.

Referring to FIG. 4, the electrodes (12 in FIG. 2) may each be formed from semi-cylindrical, annular shells, one of which is shown at 12A in FIG. 4. The shells 12A may be formed from a conductive material, e.g., stainless steel, lead, silver, silver chloride, or carbon fiber. The shells 12A may be assembled to the harness (50 in FIG. 3) at the intended location of each electrode (12 in FIG. 2) and wired to suitable signal lines in the harness 50. Each shell 12A may be covered by a turbulence suppressor layer 12B. Suitable materials for turbulence suppressor layer 12B may provide tortuosity to the path of water outside the streamer, while enabling aqueous electrical continuity between the water and the electrode shell 12A. The turbulence suppressor layer 12B may be, for example, a fluid permeable geotextile used in road preparation, or other fluid permeable materials. Moreover, it is preferable that the matrix of the turbulence suppressor layer 12B be made from electrically non-conductive material, such that motion thereof through the water does not induce electric current. The longitudinal ends of the turbulence suppressor layer 12B may also be covered with an impermeable membrane 12C so that during extrusion processing (FIG. 9) the pore spaces of the turbulence suppressor layer 12B do not become permeated with void fill material (explained below).

After assembly of the shell 12A and turbulence suppressor layer 12B to the harness (50 in FIG. 3), other streamer components may be assembled to the harness 50 to complete the mechanical harness for final processing. For example, as illustrated in FIGS. 5 and 6, buoyancy spacers (two alternative examples of which are shown at 40 and 40A) may be placed along the harness 50 at selected longitudinal positions. The spacers 40, 40A may be made from foamed polypropylene so as to provide buoyancy to the overall streamer structure. The buoyancy spacers 40, 40A may include openings for a centrally disposed strength member 42, which extends from end to end of the segment (10A in FIG. 2) and is mechanically coupled at each longitudinal end to one of the connectors (36 in FIG. 2) to enable transmission of axial loading along the streamer segment without disrupting any of the other components of the segment (10A in FIG. 2). Openings in the buoyancy spacers 40, 40A may be provided for electrical power lines 46, electrical signal telemetry lines 45, and optical fibers 44 for signal communication. Openings for signal wires 12E for the electrodes (12 in FIG. 2) may be provided as well. It is to be noted that a preferred position within the spacers 40, 40A for the signal wires 12E is a distance D away from the electrical power lines 46. Those skilled in the art will appreciate that the power lines and electrical signal telemetry lines are preferably arranged in twisted pairs to reduce radiation of electromagnetic fields therefrom.

In some embodiments, as an alternative to buoyancy spacers, buoyancy void fill material may provide the streamer segment (10A in FIG. 2) with sufficient overall buoyancy. Signal wires 12E, strength member 42, electrical power lines 46, electrical signal telemetry lines 45, and optical fibers 44 may be arranged in configurations similar to those illustrated in FIG. 5 or FIG. 6 in embodiments utilizing void fill material. Such arrangement may be maintained by tension upon the wires prior to and during extrusion. As would be appreciated by one of ordinary skill in the art with the benefit of this disclosure, suitable buoyancy void fill material would need to be somewhat more buoyant than that utilized in conjunction with buoyancy spacers.

As will be further explained below, signal processing modules (60 in FIG. 8) may be used in between segments, and such modules may accept as direct input the voltages imparted on the signal wires 12E by each respective pair of electrodes (12 in FIG. 2). In one example, electrodes (12 in FIG. 2) located on one side of a midpoint of each segment (10A in FIG. 2) may have their signal wires 12E directed to the end of the segment on that side of the midpoint. Electrodes on the other side of the midpoint may have their signal wires 12E directed to the other end of the segment. By arranging the signal wires 12E as described above, the streamer segment (10A in FIG. 2) may be connected to such signal processing modules (60 in FIG. 8) in either direction.

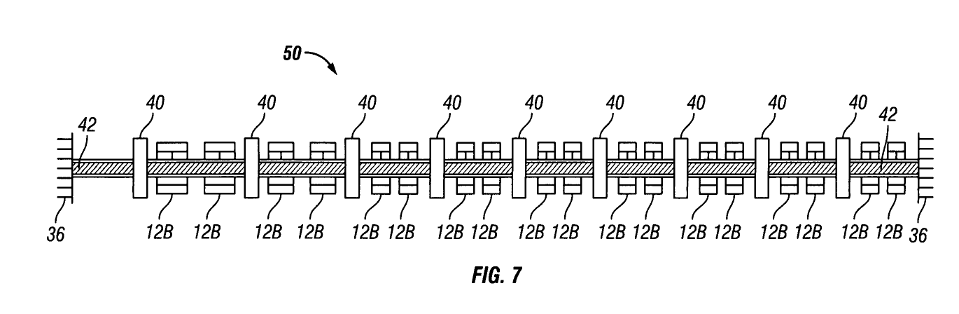

An example of a fully assembled harness 50 for a streamer segment (10A in FIG. 2) prior to extrusion processing is shown in FIG. 7. The harness may comprise strength member 42, connectors 36, and signal communication lines (e.g., signal wires 12E, electrical power lines 46, electrical signal telemetry lines 45, and optical fibers 44). As explained above, the strength member 42 may extend between and be connected to each of the connectors 36 on each longitudinal end of the harness 50. Although not shown separately for clarity of the illustration, signal wires 12E for the electrodes (12 in FIG. 2) may extend to each respective connector 36, as explained above. In some embodiments, buoyancy spacers 40 may be positioned at selected longitudinal positions and may have an overall quantity selected to provide the streamer segment (10A in FIG. 2) with suitable overall buoyancy. The turbulence suppressor layers 12B (with electrode shells 12A underneath, not shown separately) are affixed about the harness 50 at selected positions. Because the electrode shells (12A in FIG. 4) and turbulence suppressor layers 12B may be in the form of cylindrical half shells, as previously explained, they may be affixed to the harness 50 by wire ties, clamps or similar devices (not shown for clarity). The assembly shown in FIG. 7 is ready for extrusion processing, for example, as explained in U.S. Pat. No. 7,142,481 issued to Metzbower et al. As will be further explained with reference to FIG. 9, for example, the harness 50 may be drawn through a first extruder that fills void spaces therein with gellable liquid; and then exposes the liquid to curing radiation (e.g., ultraviolet radiation). The harness with void fill material may then be drawn through a second extruder that applies the jacket 30. The second extruder is preferably configured to leave openings (e.g., 32 in FIG. 4) in the jacket at the longitudinal position of the electrodes such that the electrodes (12 in FIG. 2) may maintain electrical continuity with the body of water (22 in FIG. 1).

An example signal processing module 60 that may be used to connect streamer segments (10A in FIG. 2) and process signals from the electromagnetic sensors (e.g., electrodes 12 in FIG. 2) is shown schematically in FIG. 8. The module 60 may have a high strength, corrosion resistant housing 61 such as may be made from stainless steel, titanium, or other non-magnetic alloy. The housing 61 may be cylindrically shaped and have approximately the same external diameter as the streamer segments 10A coupled adjacently thereto. The housing 61 may include connectors 36A on each longitudinal end that are configured to mate with the connectors 36 on each longitudinal end of a streamer segment 10A. The housing 61 may define a pressure resistant, water-tight interior chamber 61A in which the various functional components of the module 60 may be disposed. Signal wires 12E from electrodes (12 in FIG. 2) on one of the coupled streamer segments 10A may be conducted to part of the input terminals of a multiplexer or multi pole switch 62. Signal wires 12E from the electrodes (12 in FIG. 2) on the other connected streamer segment 10A may be connected to the remaining inputs to the multiplexer or switch 62. As explained above, the electrode signal wires 12E may be symmetrically extended toward opposed ends of the streamer segment 10A. Thus the streamer segments 10A may be symmetric, and connection of either longitudinal end thereof to the signal processing module 60 may provide essentially the same sensor connection.

Output of the multiplexer 62 may be conducted to a low noise preamplifier (LNA) 63, and then to an analog to digital converter (ADC) 64. Output of the ADC 64 may be conducted to an electrical to optical converter (EOC) 65 so that signals corresponding to voltages impressed across selected pairs of electrodes (12 in FIG. 2) may be conducted to the recording system (20 in FIG. 1) optically over fibers 44, thus avoiding electromagnetic induction interference. Power for the various components described above may be provided over power lines 46. Electrical control of the multiplexer, for example, may be provided by the recording system (20 in FIG. 1) over auxiliary communication lines 45 to cause signals to be measured and digitized only from selected pairs of electrodes. Thus the streamer (10 in FIG. 1) may be remotely electrically reconfigured as required. If still further reduction in electrical induction noise is desired, the components of the module 60 may be powered by an included battery (not shown). Such battery may be recharged with the streamer deployed in the water by a system such as described in U.S. Pat. No. 7,602,191 issued to Davidsson.

FIG. 9 shows an example of an extruder that may be used to fill and apply the jacket to the harness shown in FIG. 7 to complete the streamer segment. An extruder head 113A may include die orifices 113B and 113C for application of the void fill material and jacket materials, respectively. The extruder may also include hoppers 150 and 160. In the present example, the void fill material, disposed in hopper 150, may be in uncured form. In one example, the void fill material may be a radiation curable, cross-linking polymer dispersed in a hydrocarbon-based oil. Thus, in its uncured form, the void fill material in hopper 150 may be substantially in liquid form. The void fill material in this example preferably includes various additives to provide the liquid void fill material with thixotropic characteristics. The thixotropic characteristics would help control the flow of the material within the extruder head 113A. As the assembled mechanical harness 50 is pulled through the void fill material extruder die 113B, the thixotropic liquid void fill material is forced into all the interstitial spaces in the harness 50 and surrounds the harness 50. Immediately downstream of the void fill material extruder die 113B, the extruder head 113A may include a radiation source 152, such as an ultraviolet light source or an electron beam source, depending on the particular gelling agent used in the void fill material. Upon exposure to the radiation source 152, the void fill material may cure into a gel by reason of the polymer becoming cross-linked. The cured, filled harness 50 may then pass through the jacket material extruder die 113C. The jacket material may be liquefied in the extruder head 113A by heating, such as by heating element 116A While not shown in FIG. 9, the present example may include a vacuum former disposed at or near the outlet of the jacket extruder die 113C. The jacket material may solidify after passing through the extruder die 113C. Devices used to move the harness 50 through the extruder shown in FIG. 9 are more completely described in U.S. Pat. No. 7,142,481 issued to Metzbower et al.

Embodiments of a marine electromagnetic sensor cable made as described herein are readily completed by extrusion processing, and may provide certain benefits in operation, such as hermaphroditic connection and remote reconfigurability. A possible advantage of using gellable void fill material is to enable admission of water from the body of water (22 in FIG. 1) into the porous structure of the turbulence suppressor layer (12B in FIG. 4) over each electrode (12A in FIG. 4) without admitting water to any other part of the interior of the streamer segments (10A in FIG. 2).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for making a marine electromagnetic survey streamer, comprising:
affixing connectors to longitudinal ends of a strength member;
extending at least one signal communication line along the length of the strength member, the strength member, connectors, and at least one signal communication line forming a mechanical harness;
affixing electrodes to the mechanical harness at selected positions; and
drawing the mechanical harness through a co-extruder, the co-extruder filling void spaces in the harness with a void fill material, the co-extruder applying a jacket to an exterior of the void-filled harness.

2. The method of claim 1 further comprising affixing buoyancy spacers at selected positions along the strength member and extending the at least one signal communication line through one or more openings in the buoyancy spacers.

3. The method of claim 1, wherein the jacket comprises polyurethane.

4. The method of claim 1 further comprising providing one or more openings in the jacket proximate the selected positions of the electrodes.

5. The method of claim 1, wherein at least one of the electrodes comprises:
a conductive, semi-cylindrical, annular shell; and
a turbulence suppressor layer disposed over the shell.

6. The method of claim 5, wherein the conductive, semi-cylindrical annular shell comprises at least one conductive material selected from the group consisting of: a silver, a silver chloride, a carbon fiber, and any combination thereof.

7. The method of claim 5, wherein the turbulence suppressor layer comprises a fluid permeable, electrically non-conductive, material.

8. The method of claim 1 further comprising connecting a signal processing module to each of the connectors such that at least one electrode is connected to each signal processing module by a signal line.

9. A marine electromagnetic survey streamer segment comprising:
a strength member extending between longitudinal ends of the streamer segment;
connectors coupled to each end of the strength member;
at least one signal communication line extending along the strength member;
electrodes disposed at selected positions along the strength member;
a jacket coupled to the connectors and at least partially covering the strength member, the at least one signal communication line, and the electrodes; and
void fill material filling void spaces within the jacket.

10. The segment of claim 9, further comprising buoyancy spacers at selected positions along the strength member, and where the at least one signal communication line extends through one or more openings in the buoyancy spacers.

11. The segment of claim 9, wherein the jacket comprises polyurethane.

12. The segment of claim 9, wherein the jacket comprises one or more openings proximate the selected positions of the electrodes.

13. The segment of claim 9, wherein at least one electrode comprises:
a conductive, semi-cylindrical annular shell; and
a turbulence suppressor layer disposed over the shell.

14. The segment of claim 13, wherein the conductive, semi-cylindrical annular shell comprises at least one conductive material selected from the group consisting of: a silver, a silver chloride, a carbon fiber, and any combination thereof.

15. The segment of claim 13, wherein the turbulence suppressor layer comprises a fluid permeable, electrically non-conductive material.

16. A marine electromagnetic survey streamer system, comprising:
a plurality of streamer segments, each comprising:
a strength member extending between longitudinal ends of the streamer segment;
connectors coupled to each end of the strength member;
at least one signal communication line extending along the strength member;
electrodes disposed at selected positions along the strength member;
a jacket coupled to the connectors and at least partially covering the strength member, the at least one signal communication line, and the electrodes; and
void fill material filling void spaces within the jacket; and
a plurality of signal processing modules interconnected between adjacent streamer segments, each signal processing module comprising:
a pressure resistant housing; and
electronic circuits disposed within the pressure resistant housing, capable of receiving measurements from at least one of the electrodes of at least one of the adjacent streamer segments, and capable of communicating voltage measurements made between respective pairs of electrodes along the adjacent streamer segments to a recording system.

17. The system of claim 16, wherein the streamer segments further comprise buoyancy spacers at selected positions along the strength member, and where the at least one signal communication line extends through one or more openings in the buoyancy spacers.

18. The system of claim 16, wherein the jacket comprises polyurethane.

19. The system of claim 16, wherein the jacket comprises one or more openings proximate the selected positions of the electrodes.

20. The system of claim 16 wherein at least one electrode comprises:
a conductive, semi-cylindrical annular shell; and
a turbulence suppressor layer disposed over the shell.

21. The system of claim 20, wherein the conductive, semi-cylindrical annular shell comprises at least one conductive material selected from the group consisting of: a silver, a silver chloride, a carbon fiber, and any combination thereof.

22. The system of claim 20, wherein the turbulence suppressor layer comprises a fluid permeable, electrically non-conductive material.

23. The system of claim 16, wherein the circuit in at least one signal processing module comprises an electrically reconfigurable multiplexer coupled at its input to a plurality of the electrodes of at least one of the adjacent streamer segments, the multiplexer in signal communication with the recording system to accept command signals therefrom such that input signals only from selected ones of the plurality of the electrodes are passed through the multiplexer.

24. The system of claim 16, wherein the circuit in at least one signal processing module comprises an electrical to optical converter, and a signal communication line in the respective streamer segment comprises at least one optical fiber, the processed signals from the at least one signal processing module communicated to the recording system over the optical fiber.

25. The system of claim 16 wherein signal lines from the electrodes on each streamer segment are directed to a longitudinal end of the segment closest to each electrode, whereby the segment is connectable to the signal processing modules in either direction.

26. The method of claim 1 further comprising extending at least one electrical power line along the length of the strength member and separated from the signal communication line by at least one-third of the perimeter of the strength member.

27. The segment of claim 9 further comprising at least one electrical power line extending along the length of the strength member and separated from the signal communication line by at least one-third of the perimeter of the strength member.

28. The system of claim 16 further comprising at least one electrical power line extending along the length of the strength member and separated from the signal communication line by at least one-third of the perimeter of the strength member.
